(19) United States
(12) Patent Application Publication
(10) Pub. No.: US 2011/0070472 A1
(43) Pub. Date: Mar. 24, 2011

(54) WATERTIGHT BATTERY COVER ASSEMBLY FOR ELECTRONIC DEVICE

(75) Inventors: YANG-YANG CUI, Shenzhen City (CN); MING-ZHI ZHENG, Shenzhen City (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/728,345

(22) Filed: Mar. 22, 2010

(30) Foreign Application Priority Data
Sep. 21, 2009 (CN) 200920310912.3

(51) Int. Cl. H01M 2/10

(52) U.S. Cl. 429/97

(57) ABSTRACT

A battery cover assembly is used in an electronic device. The battery cover assembly includes a main body, a battery cover, and a gasket. The main body defines a receiving cavity including a peripheral wall. The battery cover includes a frame. The gasket is assembled in the battery cover. The frame is latched in the receiving cavity, the gasket is caught between the frame and the peripheral wall. The present disclosure further discloses an electronic device using the battery cover assembly.

### BACKGROUND

1. Technical Field

The present disclosure relates to battery cover assemblies, particularly, to a waterproof battery cover assembly for electronic devices.

2. Description of Related Art

Electronic devices usually have a removable battery cover. Usually the covers are not watertight and therefore moisture can penetrate the electronic device shortening the useful life of the electronic device.

Therefore, there is a room for improvement within the art.

### BRIEF DESCRIPTION OF THE DRAWINGS

Many aspects of a watertight battery cover assembly for electronic device using the same can be better understood with reference to the following drawings. The components in the drawings are not necessarily to scale, the emphasis instead being placed upon clearly illustrating the battery cover assembly with watertight function for electronic device using the same. Moreover, in the drawings, like reference numerals designate corresponding parts throughout the several views.

FIG. 1 is an exploded, isometric view of an exemplary battery cover assembly used in an electronic device.

FIG. 2 is an enlarged, isometric view of a battery cover and a gasket shown in FIG. 1.

FIG. 3 is an assembled, isometric view of the electronic device shown in FIG. 1.

FIG. 4 is a cross-sectional view of the electronic device taken along line IV-IV of FIG. 3.

### DETAILED DESCRIPTION

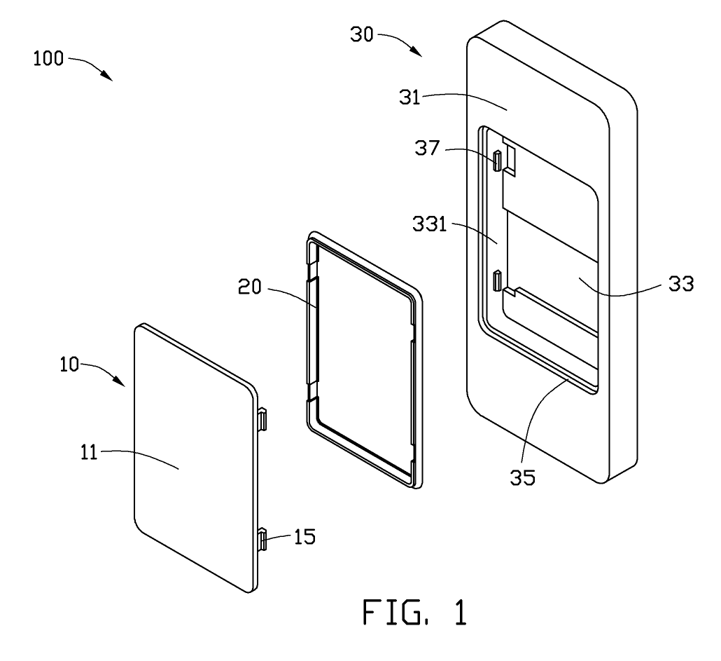

FIG. 1 shows an exemplary battery cover assembly 100 used in an electronic device, such as a mobile phone, a personal digital assistant, and so on.

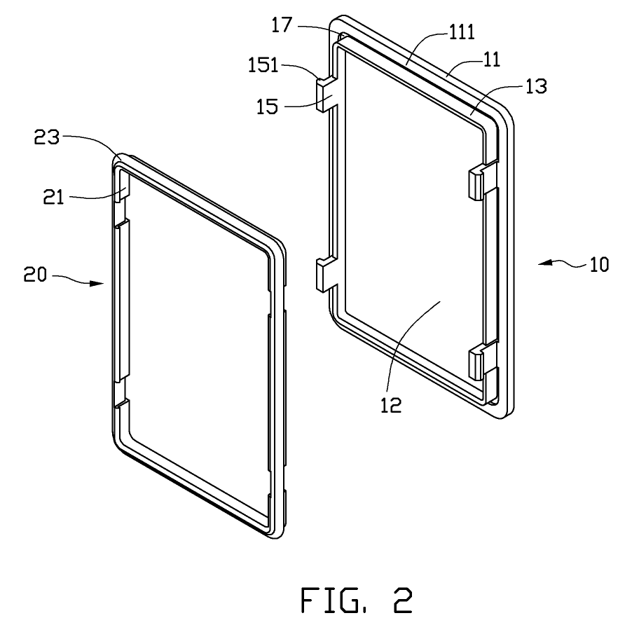

The battery cover assembly 100 includes a removable battery cover 10, a gasket 20, and a main body 30. Referring to FIG. 2, the battery cover 10 includes a plate 11, a frame 13, and two pairs of latching elements 15. The plate 11 is substantially a rectangular sheet. A flange portion 111 extends from a periphery of one side of the plate 11 to define a space 12. The frame 13 is formed immediately adjacent an inward side of the flange portion 111 defining a slot 17 therebetween for receiving the gasket 20. Each pair of the latching elements 15 is symmetrically positioned on the frame 13. Each of the latching elements 15 includes a hook 151 perpendicularly extending from a free end thereof.

The gasket 20 is made of a resilient material, such as rubber. The gasket 20 includes a first sealing portion 21 and a second sealing portion 23 integrally formed with the first sealing portion 21. The first sealing portion 21 has a shape corresponding to the frame 13. The first sealing portion 21 can be placed around the frame 13 and one end of the first sealing portion 21 is received in the slot 17. The second sealing portion 23 extends from a middle of a peripheral wall of the first sealing portion 21. The second sealing portion 23 has an arcuate surface for abutting against the main body 30 to prevent water from entering the main body 30.

The main body 30 may be portions of the electronic device and includes a base 31. The base 31 defines an opening 35 and a receiving cavity 33 communicating with each other. The opening 35 is used for receiving the battery cover 10. The receiving cavity 33 receives a battery (not shown). The receiving cavity 33 is defined by a peripheral wall 331. Two blocks 37 symmetrically extend from two sides of the peripheral wall 331 to latch the latching elements 15.

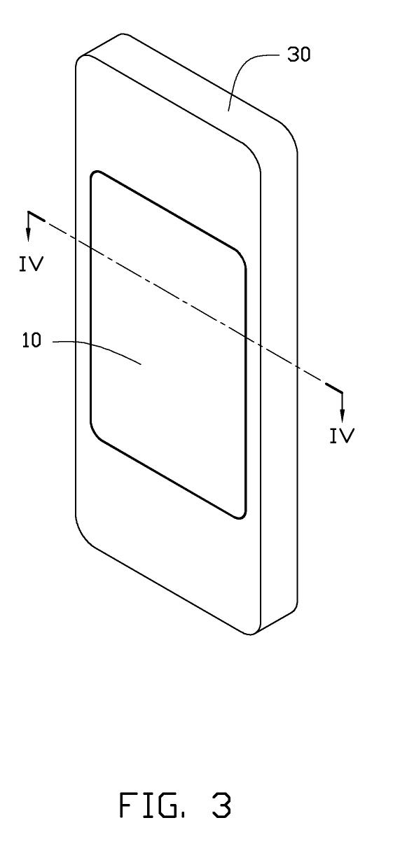

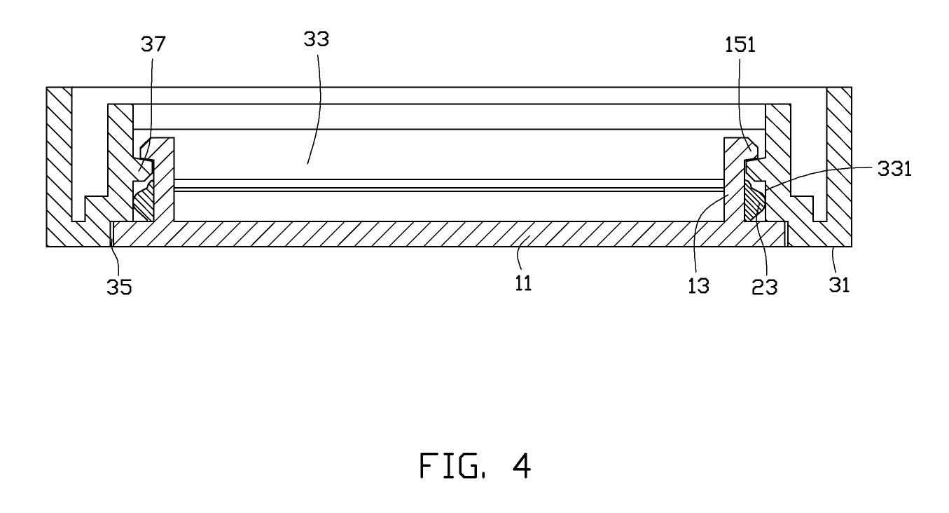

Referring to FIG. 3 and FIG. 4, in assembly, firstly, the first sealing portion 21 is placed surrounding the frame 13, and received in the slot 17. The second sealing portion 23 resists the flange portion 111. Thus, the gasket 20 is assembled to the battery cover 10. Secondly, the base 31 faces the recessed slot 12, and the battery cover 10 is pressed in the receiving cavity 33. The latching elements 15 latch the latching blocks 37. The second sealing portion 23 is received in the receiving cavity 33, and resists the peripheral wall 331. Thus, the gasket 20 is positioned between the frame 13 and the peripheral wall 331 forming a watertight sealing.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A battery cover assembly for an electronic device, the battery cover assembly comprising:
a main body defining a receiving cavity, the receiving cavity comprising a peripheral wall;
a battery cover comprising a frame; and
a gasket attached to the battery cover, the gasket including a first sealing portion and a second sealing portion integrally formed with the first sealing portion;
wherein the frame is latched in the receiving cavity, the first sealing portion is placed between the frame and the peripheral wall; the second sealing portion abuts against the main body.

2. The battery cover assembly as claimed in claim 1, wherein the battery cover further comprises two pairs of latching elements, each pair of the latching elements is symmetrically positioned on the frame; the main body comprises four latching blocks according to the latching elements, the latching elements latch the latching blocks.

3. The battery cover assembly as claimed in claim 1, wherein the battery cover further comprises a plate, a flange portion extends from four brims of the plate to surround a space, the frame positioned in the space.

4. The battery cover assembly as claimed in claim 3, wherein the frame and the flange portion define a slot, the gasket is received in the slot.

5. The battery cover assembly as claimed in claim 1, wherein the second sealing portion extends from a middle of a peripheral wall of the first sealing portion; the gasket surrounds the frame.

6. The battery cover assembly as claimed in claim 5, wherein the gasket is made of a resilient material.

7. An electronic device, comprising:
a main body defining a receiving cavity, the receiving cavity comprising a peripheral wall;
a battery cover assembly, comprising:
a battery cover comprising a frame; and
a gasket attached to the battery cover, the gasket including a first sealing portion and a second sealing portion integrally formed with the first sealing portion;
wherein the frame is latched in the receiving cavity, the first sealing portion is placed between the frame and the peripheral wall; the second sealing portion abuts against the main body.

8. The electronic device as claimed in claim 7, wherein the battery cover further comprises two pairs of latching elements, each pair of the latching elements is symmetrically positioned on the frame; the main body comprises four latching blocks according to the latching elements, the latching elements latch the latching blocks.

9. The electronic device as claimed in claim 7, wherein the battery cover further comprises a plate, a flange portion extends from four brims of the plate to surround a space, the frame positioned in the space.

10. The electronic device as claimed in claim 9, wherein the frame and the flange portion define a slot, the gasket is received in the slot.

11. The electronic device as claimed in claim 7, wherein the second sealing portion extends from a middle of a peripheral wall of the first sealing portion; the gasket surrounds the frame.

12. The electronic device as claimed in claim 11, wherein the gasket is made of a resilient material.
